(19) United States
(12) Patent Application Publication
(10) Pub. No.: US 2024/0397450 A1
(43) Pub. Date: Nov. 28, 2024

(54) POWER-BASED WIRELESS COMMUNICATION METHOD AND ELECTRONIC DEVICE

(71) Applicant: Samsung Electronics Co., Ltd., Suwon-si (KR)

(72) Inventors: Jinwoo KIM, Suwon-si (KR); Hyoungjoo LEE, Suwon-si (KR); Sanggeun LEE, Suwon-si (KR); Juhyun LEE, Suwon-si (KR); Euichang JUNG, Suwon-si (KR); Yonggue HAN, Suwon-si (KR); Chaeman LIM, Suwon-si (KR)

(21) Appl. No.: 18/793,142

(22) Filed: Aug. 2, 2024

Related U.S. Application Data
(63) Continuation of application No. PCT/KR2023/001483, filed on Feb. 2, 2023.

(30) Foreign Application Priority Data
Feb. 4, 2022 (KR) 10-2022-0015012
Mar. 25, 2022 (KR) 10-2022-0037613

(51) Int. Cl. H04W 52/36; H04W 52/14

(52) U.S. Cl. CPC H04W 52/367; H04W 52/14; H04W 52/362; H04W 52/365

(57) ABSTRACT

A method performed by an electronic device in a wireless communication system is provided. The method comprises obtaining a power reduction amount based on first target power and first transmission power of the first signal, while transmitting, through at least one antenna, a first signal supporting a first network and a second signal supporting a second network distinguished from the first network. The method comprises comparing the obtained power reduction amount with a first reference value and a second reference value less than the first reference value. The method comprises transmitting one of the first signal or the second signal through the at least one antenna by controlling a wireless communication circuit, based on the comparison result, when the power reduction amount is greater than the first reference value.

### CROSS-REFERENCE TO RELATED APPLICATION(S)

This application is a continuation application, claiming priority under § 365 (c), of an International application No. PCT/KR2023/001483, filed on Feb. 2, 2023, which is based on and claims the benefit of a Korean patent application number 10-2022-0015012, filed on Feb. 4, 2022, in the Korean Intellectual Property Office, and of a Korean patent application number 10-2022-0037613, filed on Mar. 25, 2022, in the Korean Intellectual Property Office, the disclosure of each of which is incorporated by reference herein in its entirety.

### BACKGROUND

### 1. Field

The disclosure relates to a power-based wireless communication method and an electronic device.

### 2. Description of Related Art

In order to meet the increasing demand for wireless data traffic after the commercialization of 4th generation (4G) communication systems, efforts are being made to develop improved 5th generation (5G) communication systems or pre-5G communication systems.

As a method of implementing 5G communication, a stand-alone (SA) method and a non-stand-lone (NSA) method are being considered. Among these, the NSA method may be a method using a new radio (NR) system together with the existing long term evolution (LTE) system. In the NSA method, a user terminal can use not only an eNB of the LTE system but also a gNB of the NR system. Dual connectivity refers to a technology of enabling the user terminal to use heterogeneous communication systems. In the 5G NSA method, it is being discussed that the dual connectivity proposed by 3rd generation partnership project (3GPP) release-12 is implemented in a method using the LTE system as a master node and using the NR system as a secondary node.

Also, a dynamic power sharing method of when the sum of transmission power of the NR system and transmission power of the LTE system is greater than a maximum allowable power value in a dual connectivity environment using the NR system and the LTE system together, controlling the sum of the transmission power of the NR system and the transmission power of the LTE system to be less than or equal to the maximum allowable power value by reducing power of the NR system is being used.

The above information is presented as background information only to assist with an understanding of the disclosure. No determination has been made, and no assertion is made, as to whether any of the above might be applicable as prior art with regard to the disclosure.

### SUMMARY

If an X scale value is received from a base station in performing a dynamic power sharing operation, no data of an NR network may be transmitted when a transmission power reduction amount of the NR network is greater than the X scale.

At this time, the X scale can be set as 0 dB or 6 dB, and when the X scale is set as 0 dB, most of data transmission through the NR network can be canceled and thus the communication performance of an electronic device can be deteriorated.

Various embodiments disclosed in this document may prevent or reduce network performance deterioration resulting from cancellation of data transmission, by controlling a transmission path to transmit data through only a single network among NR or LTE according to a specified condition.

Aspects of the disclosure are to address at least the above-mentioned problems and/or disadvantages and to provide at least the advantages described below. Accordingly, an aspect of the disclosure is to provide a power-based wireless communication method and an electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a wireless communication circuit, at least one antenna connected to the wireless communication circuit and transmitting a first signal supporting a first network and a second signal supporting a second network distinguished from the first network, memory storing one or more computer programs, and one or more processors communicatively coupled to the wireless communication circuit, the at least one antenna, and the memory, wherein the one or more computer programs include computer-executable instructions that, when executed by the one or more processors individually or collectively, cause the electronic device to: obtain a power reduction amount based on first target power and first transmission power of the first signal while transmitting the first signal and the second signal through the at least one antenna, compare the power reduction amount with a first reference value and a second reference value less than the first reference value, and when the power reduction amount is greater than the first reference value based on the comparison result, transmit one of the first signal or the second signal through the at least one antenna by controlling the wireless communication circuit.

In accordance with another aspect of the disclosure, a wireless communication method is provided. The wireless communication method includes, while transmitting, through at least one antenna, a first signal supporting a first network and a second signal supporting a second network distinguished from the first network, obtaining a power reduction amount based on first target power and first transmission power of the first signal, comparing the obtained power reduction amount with a first reference value and a second reference value less than the first reference value, and when the power reduction amount is greater than the first reference value based on the comparison result, transmitting one of the first signal or the second signal through the at least one antenna by controlling a wireless communication circuit.

In accordance with another aspect of the disclosure, an electronic device is provided. The electronic device includes a wireless communication circuit, at least one antenna connected to the wireless communication circuit and transmitting a first signal supporting a first network and/or a second signal supporting a second network distinguished from the first network, and at least one processor electrically connected to the wireless communication circuit. The at least one processor may obtain a power reduction amount based on first target power and first transmission power of the first signal while transmitting the first signal and the second signal through the at least one antenna, when the power reduction amount is greater than a reference value, obtain first information about the first network and second information about the second network, and transmit one of the first signal or the second signal through the at least one antenna by controlling the wireless communication circuit, based on at least part of the first information and the second information.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include while transmitting, through at least one antenna, a first signal supporting a first network and a second signal supporting a second network distinguished from the first network, obtaining a power reduction amount based on first target power and first transmission power of the first signal, comparing the obtained power reduction amount with a first reference value and a second reference value less than the first reference value, and when the power reduction amount is greater than the first reference value, based on the comparison result, transmitting one of the first signal or the second signal through the at least one antenna by controlling a wireless communication circuit.

According to various embodiments disclosed in this document, transmission power for signals supporting different networks may be controlled to satisfy the specific absorption rate (SAR) standard in a state of transmitting an NR signal and an LTE signal.

Also, according to various embodiments, a transmission path may be controlled to transmit only a signal supporting one of an NR network or an LTE network, based on a transmission power reduction amount of an NR signal due to dynamic power sharing, in a state of transmitting the NR signal and an LTE signal.

Also, according to various embodiments, a transmission path may be controlled to transmit only a signal of a single network depending on whether a predetermined function is set, in a state of transmitting an NR signal and an LTE signal.

Also, according to various embodiments, a transmission path may be controlled to transmit only a signal of a single network, based on uplink throughputs of both an NR signal and an LTE signal, in a state of transmitting the NR signal and the LTE signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment of the disclosure;

FIG. 2 is a block diagram of an electronic device for supporting legacy network communication and 5G network communication according to an embodiment of the disclosure;

FIG. 3 illustrates an antenna structure supporting communication of a multiple signal according to an embodiment of the disclosure;

FIG. 4 illustrates dynamic power sharing of transmission power of a first signal and transmission power of a second signal according to an embodiment of the disclosure;

FIG. 5 is a flowchart illustrating an operation of transmitting one of a first signal or a second signal, based on a power reduction amount of the first signal, according to an embodiment of the disclosure;

FIG. 6 is a flowchart illustrating an operation of when a power reduction amount of a first signal is less than a first reference value, transmitting one of the first signal or a second signal, based on whether a specified condition is satisfied, according to an embodiment of the disclosure;

FIG. 7 illustrates an operation of selecting and transmitting one of a first signal or a second signal according to an embodiment of the disclosure;

FIG. 8 is a flowchart illustrating an operation of selecting and transmitting one of a first signal or a second signal depending on whether a function is set to a first network and a second network, according to an embodiment of the disclosure; and

FIG. 9 is a flowchart illustrating an operation of selecting and transmitting one of a first signal or a second signal, based on first information of a first network and second information of a second network, according to an embodiment of the disclosure.

Throughout the drawings, it should be noted that like reference numerals are used to depict the same or similar elements, features, and structures.

### DETAILED DESCRIPTION

The following description with reference to the accompanying drawings is provided assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, various embodiments of the disclosure are disclosed with reference to the attached drawings. However, it should be understood that this is not intended to limit the disclosure to specific embodiments, and embraces various modifications, equivalents, and/or alternatives of embodiments of the disclosure.

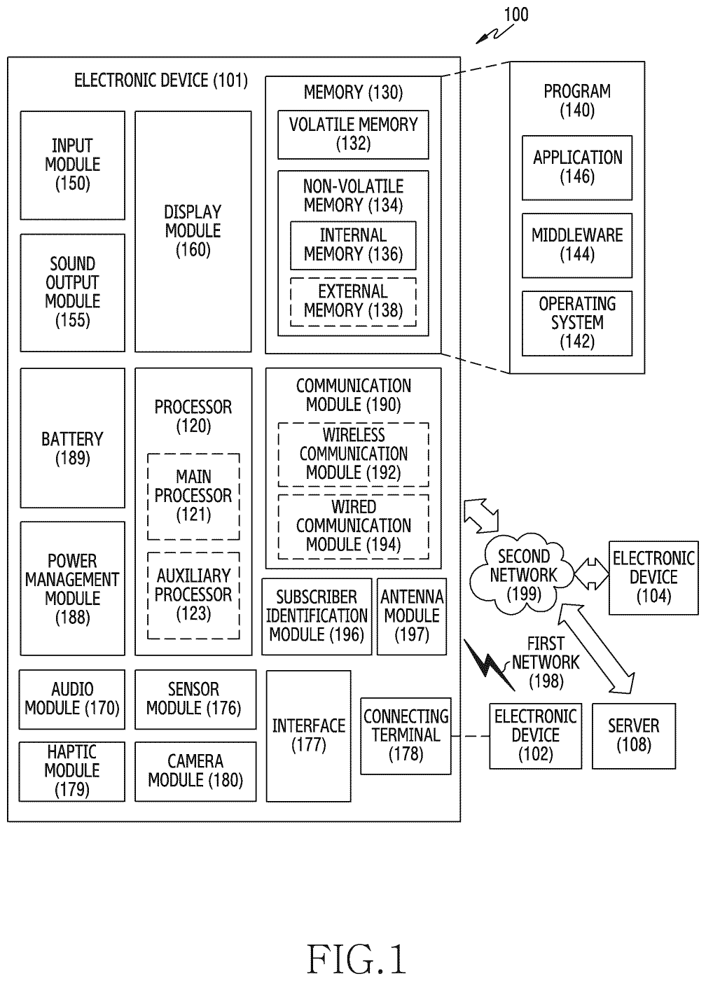

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). In an embodiment, the electronic device 101 may communicate with the electronic device 104 via the server 108. According to another embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In other embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. In another embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may be configured to control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one embodiment, the auxiliary processor 123 (e.g., an image signal processor or a communication processor) may be implemented as part of another component (e.g., the camera module 180 or the communication module 190) functionally related to the auxiliary processor 123. According to another embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may, for example, include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to another embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to another embodiment, the display module 160 may include a touch sensor adapted to detect a touch, or a pressure sensor adapted to measure the intensity of force incurred by the touch.

The audio module 170 may convert a sound into an electrical signal and vice versa. The audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. In another embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may, for example, include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to another embodiment, the camera module 180 may include one or more lenses, image sensors, image signal processors, or flashes.

The power management module 188 may manage power supplied to the electronic device 101. According to another embodiment, the power management module 188 may be implemented as at least part of, for example, a power management integrated circuit (PMIC).

The battery 189 may supply power to at least one component of the electronic device 101. In an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to one embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. The antenna module 197 may include an antenna including a radiating element composed of a conductive material or a conductive pattern formed in or on a substrate (e.g., a printed circuit board (PCB)). According to another embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. The mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 or 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to another embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may, for example, include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities, and some of the multiple entities may be separately disposed in different components. According to some embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to other embodiments, operations performed by the module, the program, or another component may be carried out sequentially, in parallel, repeatedly, or heuristically, or one or more of the operations may be executed in a different order or omitted, or one or more other operations may be added.

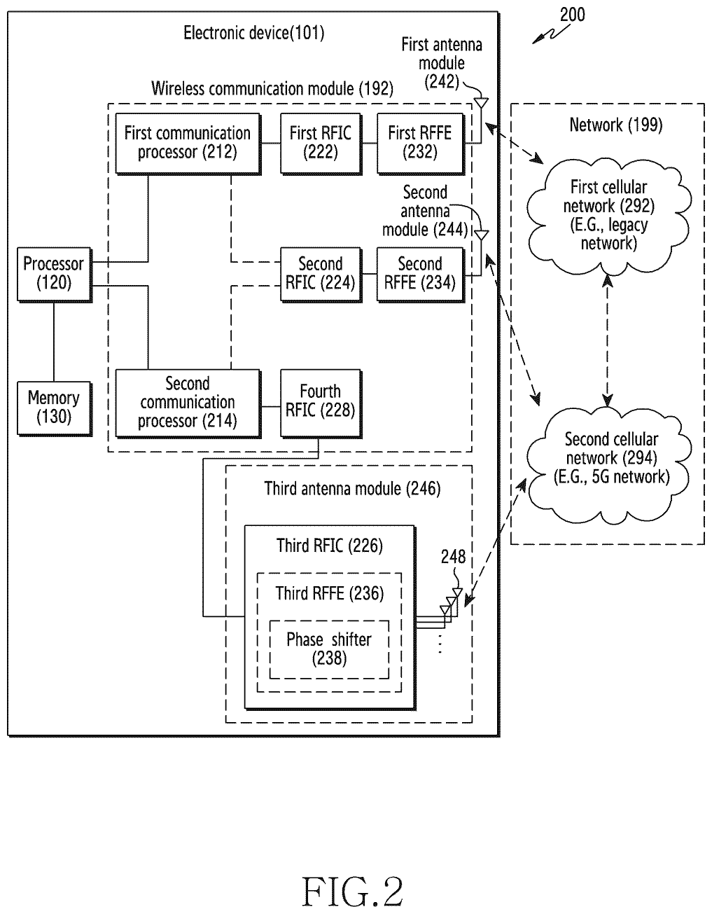

FIG. 2 is a block diagram of an electronic device for supporting legacy network communication and 5G network communication according to an embodiment of the disclosure.

Referring to FIG. 2, a structure 200 includes an electronic device 101 that may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include a processor 120 and memory 130. The network 199 may include a first network 292 and a second network 294. In an embodiment, the electronic device 101 may further include at least one of the components shown in FIG. 1, and the network 199 may further include at least one other network. In another embodiment, the first communication processor 212, the second communication processor 214, the first RFIC 222, the second RFIC 224, the fourth RFIC 228, the first RFFE 232, and the second RFFE 234 may form at least a part of the wireless communication module 192. According to yet another embodiment, the fourth RFIC 228 may be omitted, or be included as a part of the third RFIC 226.

The first communication processor 212 may support establishment of a communication channel in a band to be used for wireless communication with the first network 292, and support legacy network communication through the established communication channel. The first network 292 may be a legacy network including a 2nd generation (2G), 3^{rd} generation (3G), 4G, or long term evolution (LTE) network. The second communication processor 214 may support establishment of a communication channel corresponding to a specified band (e.g., about 6 GHz to about 60 GHZ) among bands to be used for wireless communication with the second network 294, and support 5G network communication through the established communication channel. According to some embodiments, the second network 294 may be a 5G network defined by 3GPP. Additionally, according to an embodiment, the first communication processor 212 or the second communication processor 214 may support establishment of a communication channel corresponding to another specified band (e.g., about 6 GHz or less) among the bands to be used for wireless communication with the second network 294, and support 5G network communication through the established communication channel. According to an embodiment, the first communication processor 212 and the second communication processor 214 may be implemented within a single chip or a single package. According to other embodiments, the first communication processor 212 or the second communication processor 214 may be formed within a single chip or a single package together with the processor 120, the auxiliary processor 123, or the communication module 190.

At transmission, the first RFIC 222 may convert a baseband signal generated by the first communication processor 212 into a radio frequency (RF) signal of about 700 MHz to about 3 GHZ used in the first network 292 (e.g., the legacy network). At reception, an RF signal may be obtained from the first network 292 (e.g., the legacy network) through an antenna (e.g., the first antenna module 242), and may be preprocessed through an RFFE (e.g., the first RFFE 232). The first RFIC 222 may convert the preprocessed RF signal into a baseband signal for processing by the first communication processor 212.

At transmission, the second RFIC 224 may, for example, convert a baseband signal generated by the first communication processor 212 or the second communication processor 214 into an RF signal (hereinafter, a 5G Sub6 RF signal) of a Sub6 band (e.g., about 6 GHz or less) used in the second network 294 (e.g., the 5G network). At reception, a 5G Sub6 RF signal may be obtained from the second network 294 (e.g., the 5G network) through an antenna (e.g., the second antenna module 244) and be preprocessed through an RFFE (e.g., the second RFFE 234). The second RFIC 224 may convert the preprocessed 5G Sub6 RF signal into a baseband signal for processing by a corresponding communication processor among the first communication processor 212 or the second communication processor 214.

The third RFIC 226 may, for example, convert a baseband signal generated by the second communication processor 214 into an RF signal (hereinafter, a 5G Above6 RF signal) of a 5G Above6 band (e.g., about 6 GHz to about 60 GHZ) to be used in the second network 294 (e.g., the 5G network). At reception, a 5G Above6 RF signal may be obtained from the second network 294 (e.g., the 5G network) through an antenna (e.g., the antenna 248) and be preprocessed through a third RFFE 236. The third RFIC 226 may convert the preprocessed 5G Above6 RF signal into a baseband signal for processing by the second communication processor 214. In an embodiment, the third RFFE 236 may be formed as a part of the third RFIC 226.

In another embodiment, the electronic device 101 may include the fourth RFIC 228 separately from the third RFIC 226 or at least as a part thereof. In this case, the fourth RFIC 228 may convert a baseband signal generated by the second communication processor 214 into an RF signal (hereinafter, an IF signal) of an intermediate frequency band (e.g., about 9 GHz to about 11 GHZ) and then, transfer the IF signal to the third RFIC 226. The third RFIC 226 may convert the IF signal into a 5G Above6 RF signal. At reception, a 5G Above6 RF signal may be received from the second network 294 (e.g., the 5G network) through an antenna (e.g., the antenna 248) and be converted into an IF signal by the third RFIC 226. The fourth RFIC 228 may convert the IF signal into a baseband signal for processing by the second communication processor 214.

In yet another embodiment, the first RFIC 222 and the second RFIC 224 may be implemented as at least a part of a single chip or single package. According to an embodiment, the first RFFE 232 and the second RFFE 234 may be implemented as at least a part of a single chip or single package. At least one of the first antenna module 242 or the second antenna module 244 may be omitted or be coupled with another antenna module and process RF signals of a plurality of corresponding bands.

According to an embodiment, the third RFIC 226 and the antenna 248 may be disposed on the same substrate and form a third antenna module 246. For example, the wireless communication module 192 or the processor 120 may be disposed on a first substrate (e.g., a main PCB). In this case, the third RFIC 226 may be arranged in a partial area (e.g., a lower surface) of a second substrate (e.g., a sub PCB) separate from the first substrate, and the antenna 248 may be arranged in another partial area (e.g., an upper surface) of the second substrate and thus, the third antenna module 246 may be formed. The third RFIC 226 and the antenna 248 may be disposed on the same substrate, thereby reducing the length of a transmission line therebetween. This, for example, may reduce a loss (e.g., attenuation), due to the transmission line, of a signal of a high frequency band (e.g., about 6 GHz to about 60 GHZ) used in 5G network communication. Because of this, the electronic device 101 may improve the quality or speed of communication with the second network 294 (e.g., the 5G network).

According to another embodiment, the antenna 248 may be formed as an antenna array including a plurality of antenna elements that may be used for beamforming. In this case, the third RFIC 226 may include, for example, a plurality of phase shifters 238 corresponding to the plurality of antenna elements as a part of the third RFFE 236. At transmission, each of the plurality of phase shifters 238 may shift the phase of a 5G Above6 RF signal to be transmitted to outside (e.g., a base station of a 5G network) of the electronic device 101 through the corresponding antenna element. At reception, each of the plurality of phase shifters 238 may shift the phase of a 5G Above6 RF signal received from the outside through the corresponding antenna element into the same or substantially the same phase. This enables transmission or reception through beamforming between the electronic device 101 and the outside.

The second network 294 (e.g., the 5G network) may operate independently (e.g., stand-alone (SA)) of, or operate in connection (non-stand alone (NSA)) to the first network 292 (e.g., the legacy network). For example, the 5G network may have only an access network (e.g., a 5G radio access network (RAN) or a next generation RAN (NG RAN)) and have no core network (e.g., a next generation core (NGC)). The electronic device 101 may access an access network of the 5G network and then, access an external network (e.g., the Internet) under the control of a core network (e.g., an evolved packed core (EPC)) of the legacy network. Protocol information (e.g., LTE protocol information) for communication with the legacy network or protocol information (e.g., new radio (NR) protocol information) for communication with the 5G network may be stored in the memory 230 and be accessed by other components (e.g., the processor 120, the first communication processor 212, or the second communication processor 214).

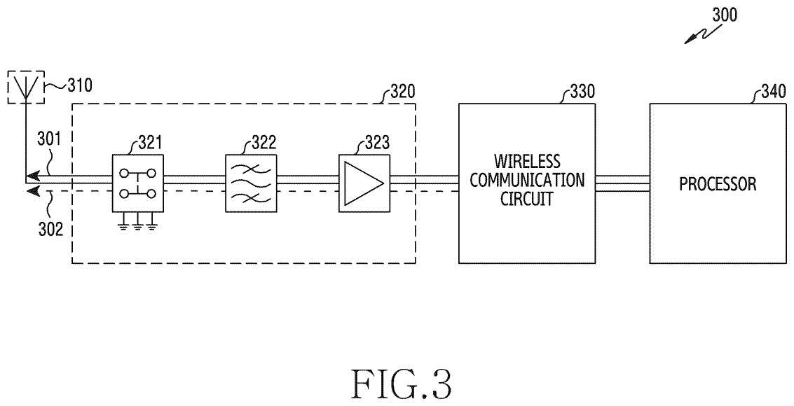

FIG. 3 illustrates an antenna structure supporting communication of a multiple signal according to an embodiment of the disclosure.

Referring to FIG. 3, an antenna structure 300 of an embodiment may include at least one antenna 310 (e.g., the second antenna module 244 of FIG. 2), a radio frequency front-end (RFFE) 320 (e.g., the second RFFE 234 of FIG. 2), a wireless communication circuit 330, and at least one processor 340. The wireless communication circuit 330 may be electrically connected to the at least one antenna 310 and the at least one processor 340. According to another embodiment (not shown), some of the above-described components may be omitted, and other components may be added.

The antenna structure 300 may support a first network (or a first communication protocol) for transceiving a first signal 301 and a second network (or a second communication protocol) for transceiving a second signal 302 distinguished from the first signal 301. For example, the first network may be referred to as a 5G communication protocol or a new radio (NR) communication protocol, and the second network may be referred to as a 4G communication protocol or an LTE protocol.

According to an embodiment, the antenna structure 300 may support communication for a multiple signal through dual connectivity or carrier aggregation (CA). According to another embodiment, the antenna structure 300 may support a network for transmitting and/or receiving the first signal 301 and the second signal 302 having a frequency band distinguished from that of the first signal 301.

The at least one antenna 310 may be connected to the wireless communication circuit 330 through the RFFE 320. The at least one antenna 310 of an embodiment may transfer a received radio frequency (RF) signal to the wireless communication circuit 330 through the RFFE 320. The wireless communication circuit 330 of an embodiment may transfer an RF signal to the at least one antenna 310 through the RFFE 320.

According to an embodiment, the wireless communication circuit 330 may include a transceiver and a modem. The transceiver and the modem may be integrated and form at least a part of the wireless communication circuit 330.

According to an embodiment, the RFFE 320 may include a tuner 321, a band pass filter (BPF) 322, and an amplifier 323.

The tuner 321 may include at least some of at least one switch, at least one variable capacitor, and at least one inductor, but the construction of the tuner 321 is not limited to the above-described construction.

According to another embodiment, the wireless communication circuit 330 may control the phase and/or resonant frequency of an RF signal by controlling the tuner 321. For example, the wireless communication circuit 330 may control the phase of the RF signal by adjusting a value of the at least one variable capacitor or controlling the at least one switch.

According to yet another embodiment, the wireless communication circuit 330 may transfer a signal of a specified frequency band, in accordance with a frequency band of an RF signal, through the BPF 322. The wireless communication circuit 330 may separate and transmit a plurality of RF signals in accordance with a frequency through the BPF 322.

According to an embodiment, the wireless communication circuit 330 may control, through the amplifier 323, the strength of a signal that is transferred from the wireless communication circuit 330 to the at least one antenna 310 or transferred from the at least one antenna 310 to the wireless communication circuit 330.

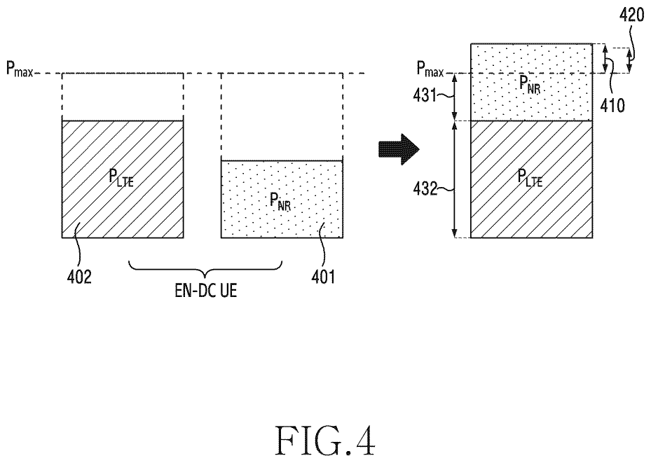

FIG. 4 illustrates dynamic power sharing of transmission power of a first signal and transmission power of a second signal according to an embodiment of the disclosure.

Referring to FIGS. 3 and 4 together, the electronic device 101 may control first target power 401 wherein the sum of first transmission power 431 of a first signal 301 and second transmission power 432 of a second signal 302 becomes less than or equal to maximum power Pmax, through dynamic power sharing that controls transmission power of the first signal 301 and transmission power of the second signal 302 by using the wireless communication circuit 330.

The first target power 401 of an embodiment may be referred to as power required to transmit the first signal 301. For example, the first target power 401 may be referred to as transmission power or target power, but is not limited thereto.

The maximum power Pmax of an embodiment may be, for example, determined to satisfy the specific absorption rate (SAR) standard. SAR of an embodiment may be referred to as the amount of energy of a radio frequency (RF) signal absorbed by the human body. The SAR standard of an embodiment may be referred to as a standard for regulating SAR below a certain level.

The SAR standard may include SAR backoff that is determined based on at least some of a user's holding state of the electronic device 10, a frequency band of a transceived signal, a transmission frequency within a frequency band, and radiation performance.

In order to prevent the case where the sum of the first transmission power 431 and the second transmission power 432 of an embodiment does not satisfy the SAR standard, the maximum power Pmax may be set to satisfy the SAR standard. The at least one processor 340 of an embodiment may control to transmit one of the first signal 301 and the second signal 302 in order that the sum of the first transmission power 431 and the second transmission power 432 of an embodiment satisfies the SAR standard. A detailed description of this is made below.

The at least one processor 340 may control the first target power 401 wherein the sum of the first target power 401 for transmitting the first signal 301 and the second target power 402 for transmitting the second signal 302 becomes less than or equal to the maximum power Pmax, in a dual connectivity or CA environment for transmitting the first signal 301 and the second signal 302.

According to another embodiment, the at least one processor 340 may determine the second target power 402 of the second signal 302 as the second transmission power 432, and may determine part of the first target power 401 as the first transmission power 431 within a range where the sum of the first target power 401 and the second target power 402 becomes less than or equal to the maximum power Pmax. For example, the wireless communication circuit 330 (or the at least one processor 340) may determine the second transmission power 432 of the second signal 302 within a range of the maximum power Pmax, and may determine, as the first transmission power 431, at least part of the maximum power Pmax excluding the second transmission power 432.

According to still another embodiment, by controlling the wireless communication circuit 330, the at least one processor 340 may transmit the second signal 302 at the second transmission power 432 while transmitting the first signal 301 at the first transmission power 431.

When the sum of the first target power 401 of the first signal 301 and the second target power 402 of the second signal 302 exceeds the maximum power Pmax, the at least one processor 340 may reduce the first target power 401 and transmit the first signal 301. For example, when the sum of the first target power 401 of the first signal 301 and the second target power 402 of the second signal 302 exceeds the maximum power Pmax, the wireless communication circuit 330 may transmit the first signal 301 at the first transmission power 431 that is obtained by reducing the first target power 401 as much as an amount by which the sum of the first target power 401 and the second target power 402 exceeds the maximum power Pmax.

The at least one processor 340 may reduce the first target power 401 as much as an amount by which the sum of the first target power 401 and the second target power 402 exceeds the maximum power Pmax, and may determine the amount of the reduced power as the power reduction amount 410. According to another embodiment, the at least one processor 340 may obtain the power reduction amount 410, based on first transmission power 431 of first signal 301 after controlling for the sum of the first target power 401 of the first signal 301 and the second target power 402 becoming less than or equal to the maximum power Pmax. For example, the at least one processor 340 may determine (or obtain) a difference between the first target power 401 of the first signal 301 and the first transmission power 431 of the first signal 301 as the power reduction amount 410.

According to an embodiment, the at least one processor 340 may control a transmission path, based on the determined (or obtained) power reduction amount 410. The wireless communication circuit 330 (or the at least one processor 340) may control the transmission path, based on the determined (or obtained) power reduction amount 410 and a first reference value. However, a detailed description of this is provided below.

According to another embodiment (not shown), the wireless communication circuit 330 (or the at least one processor 340) may determine the first transmission power 431 wherein the sum of the first target power 401 of the first signal 301 and the second target powers 402 of the second signal 302 becomes less than or equal to specified maximum power Pmax per unit hour.

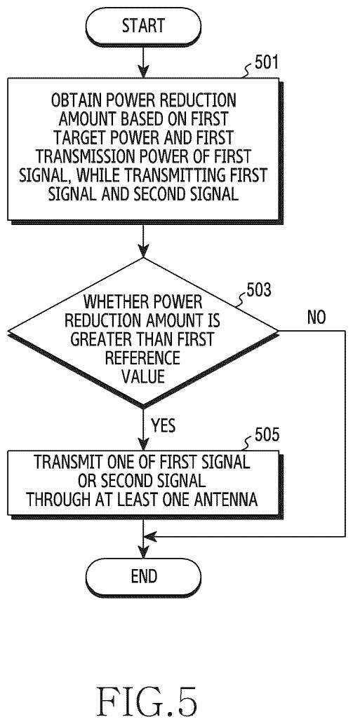

FIG. 5 is a flowchart illustrating an operation of transmitting one of a first signal or a second signal, based on a power reduction amount of the first signal according to an embodiment of the disclosure.

Referring to FIG. 5, the electronic device 101 of an embodiment may transmit one of the first signal 301 or the second signal 302 through the at least one antenna 310, based on whether the power reduction amount 410 of the first signal 301 is greater than a first reference value.

According to an embodiment, in a dual connectivity or CA environment of transmitting the first signal 301 and the second signal 302, when the power reduction amount 410 of the first signal 301 due to the dynamic power sharing is greater than the first reference value, transmission of data included in the first signal 301 may be canceled and therefore, in order to prevent this, the electronic device 101 may control a transmission path, thereby transmitting one of the first signal 301 or the second signal 302.

In operation 501, while transmitting the first signal 301 and the second signal 302 through the at least one antenna 310, the electronic device 101 may obtain the power reduction amount 410, based on the first target power 401 of the first signal 301 and the first transmission power 431. For example, in operation 501, the electronic device 101 may determine, as the power reduction amount 410, a difference between the first target power 401 of the first signal 301 and the first transmission power 431. According to an embodiment, in operation 501, the electronic device 101 may determine, as the power reduction amount 410, power by which the sum of the first target power 401 and the second target power 402 exceeds the maximum power Pmax, in the dual connectivity or CA environment of transmitting the first signal 301 and the second signal 302 through the at least one antenna 310.

In operation 503, the electronic device 101 may determine whether the power reduction amount 410 is greater than a first reference value. According to an embodiment, in operation 503, the electronic device 101 may determine whether the power reduction amount 410 obtained through operation 501 is greater than a predetermined first reference value. According to an embodiment, the electronic device 101 may compare the power reduction amount 410 obtained through operation 501 with a first reference value and a second reference value 420 less than the first reference value.

The second reference value 420 of an embodiment may be referred to as an X scale. At this time, the second reference value 420 referred to as the X scale may be referred to as about 0 dB or about 6 dB, but is not limited thereto. According to an embodiment, the first reference value may be determined based on the second reference value 420. According to an embodiment, the first reference value may be referred to as a value obtained by adding a predetermined margin to the second reference value 420.

The electronic device 101 may, for example, receive the second reference value 420 from a base station through the wireless communication circuit 330. According to an embodiment, the electronic device 101 may receive a radio resource control (RRC) message from the base station through the wireless communication circuit 330 and obtain the second reference value 420 included in the received RRC message. For example, the electronic device 101 may transmit a signal requesting the second reference value 420 (or the RRC message) to the base station and receive a signal including the second reference value 420 from the base station.

According to another embodiment (not shown), the electronic device 101 may include the memory 130 in which the second reference value 420 is previously stored. For example, when the electronic device 101 receives no separate message from the base station, the electronic device 101 may determine, as the second reference value 420, a value (e.g., 0 dB) previously stored in the memory 130. For another example, when a message received from the base station includes no information about the second reference value 420, the electronic device 101 may determine, as the second reference value 420, the value (e.g., 0 dB) previously stored in the memory 130.

In an embodiment, when the power reduction amount 410 is greater than the first reference value, in operation 505, the electronic device 101 may transmit one of the first signal 301 or the second signal 302 through the at least one antenna 310. According to another embodiment, when the power reduction amount 410 is greater than the first reference value, in operation 505, the electronic device 101 may transmit one of the first signal 301 or the second signal 302 through the at least one antenna 310 by controlling the transmission path. For example, when the power reduction amount 410 of the first signal 301 is greater than the first reference value, the electronic device 101 may transmit only the second signal 302 by controlling the transmission path. A detailed description of this is made below.

The operations described in FIG. 5 may be referred to as being performed by the wireless communication circuit 330 or the at least one processor 340.

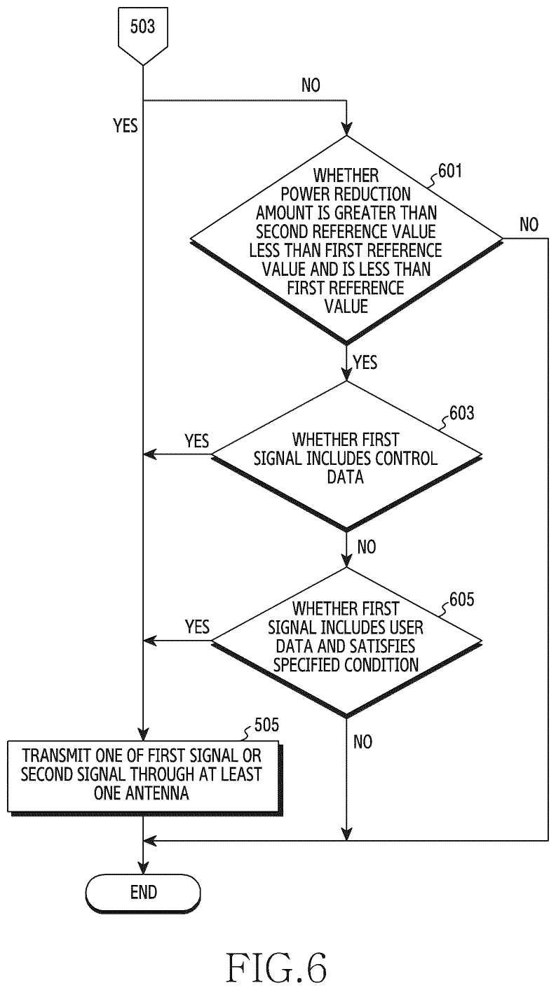

FIG. 6 is a flowchart illustrating an operation of, when a power reduction amount of a first signal is less than a first reference value, transmitting one of the first signal or a second signal, based on whether a specified condition is satisfied, according to an embodiment of the disclosure.

Referring to FIGS. 5 and 6 together, when the power reduction amount 410 of the first signal 301 is less than the first reference value, the electronic device 101 of an embodiment may transmit one of the first signal 301 or the second signal 302 through the at least one antenna 310, by controlling a transmission path depending on whether the power reduction amount 410 of the first signal 301 satisfies a specified condition.

In operation 601, the electronic device 101 may determine whether the power reduction amount 410 of the first signal 301 is less than the first reference value and is greater than the second reference value 420.

According to an embodiment, when the power reduction amount 410 of the first signal 301 is less than the first reference value and is greater than the second reference value 420, in operation 603, the electronic device 101 may determine whether the first signal 301 includes control data (e.g., physical uplink control channel (PUCCH) transmission information).

According to another embodiment, when the first signal 301 includes control data, if transmission of the control data is canceled, the performance of communication between the base station and the electronic device 101 may be deteriorated and thus, in operation 505, the electronic device 101 may transmit one of the first signal 301 or the second signal 302 through the at least one antenna 310 by controlling the transmission path. For example, when the power reduction amount 410 of the first signal 301 is less than the first reference value and is greater than the second reference value 420, and the first signal 301 includes the PUCCH transmission information, in operation 505, the electronic device 101 may transmit only the second signal 302 by controlling the transmission path.

When the first signal 301 includes no control data, in operation 605, the electronic device 101 may determine whether the first signal 301 includes user data (e.g., a physical uplink shared channel (PUSCH)) and satisfies a specified condition. According to an embodiment, when the first signal 301 includes the user data, communication between the base station and the electronic device 101 may be normally performed through retransmission, so the electronic device 101 may control the transmission path depending on whether the first signal 301 satisfies the specified condition.

The specified condition of an embodiment may be referred to as whether the number of times where the power reduction amount 410 is greater than or equal to the second reference value 420 is greater than or equal to a predetermined first threshold value during a specified time. For example, when the first signal 301 includes the user data, the electronic device 101 may determine that the specified condition is satisfied, when an event that the power reduction amount 410 of the first signal 301 is greater than or equal to the second reference value 420 occurs about 640 times or more per 40 ms.

The specified condition of another embodiment may be referred to as whether the number of times where the power reduction amount 410 is greater than or equal to the second reference value 420 occurs continuously greater than or equal to a predetermined second threshold value during the specified time. For example, when the first signal 301 includes the user data, the electronic device 101 may determine that the specified condition is satisfied, when the event that the power reduction amount 410 of the first signal 301 is greater than or equal to the second reference value 420 occurs continuously about 10 times or more.

According to another embodiment, the specified condition may be referred to as whether a rate at which the power reduction amount 410 is greater than or equal to the second reference value 420 is greater than or equal to a predetermined third threshold value during the specified time. For example, when the first signal 301 includes the user data, the electronic device 101 may determine that the specified condition is satisfied, when the rate at which the power reduction amount 410 of the first signal 301 is greater than or equal to the second reference value 420 is about 50% or more.

When the first signal 301 includes the user data and satisfies the specified condition, in operation 505, the electronic device 101 may transmit one of the first signal 301 or the second signal 302 through the at least one antenna 310. According to an embodiment, when the first signal 301 includes the user data and satisfies the specified condition, in operation 505, the electronic device 101 may transmit one of the first signal 301 or the second signal 302 by controlling the transmission path.

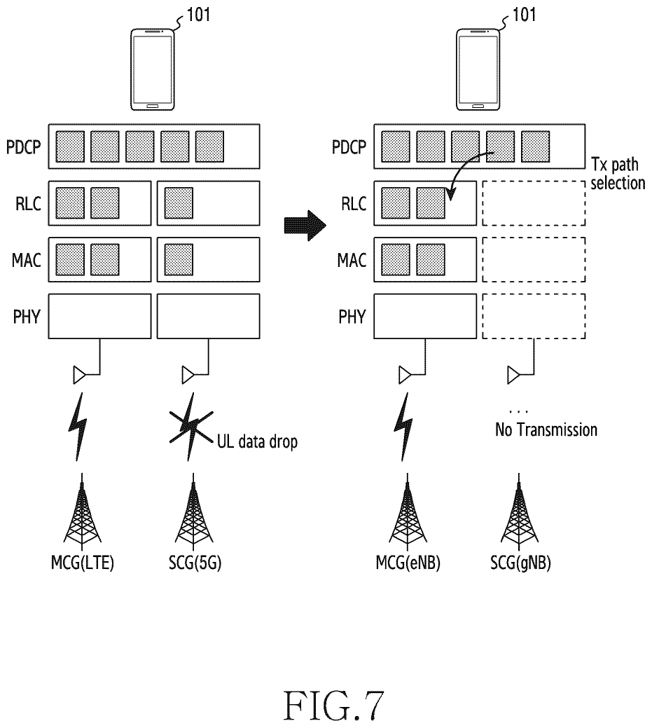

FIG. 7 illustrates an operation of selecting and transmitting one of a first signal or a second signal according to an embodiment of the disclosure.

Referring to FIG. 7, in an evolved universal mobile telecommunications system (UMTS) terrestrial radio access network (E-UTRAN) new radio-dual connectivity (EN-DC) environment of transmitting the first signal 301 and the second signal 302, in order to prevent the transmission of the first signal 301 from being cancelled, the electronic device 101 of an embodiment may transmit one of the first signal 301 or the second signal 302 by controlling a transmission path. The operation of FIG. 7 of an embodiment may be referred to as a specific operation of operation 505 of FIGS. 5 and 6.

In order to prevent the transmission of the first signal 301 from being cancelled, the electronic device 101 may transmit one of the first signal 301 or the second signal 302 by controlling the transmission path in accordance with the determination included in the operation of FIG. 5 or 6.

According to an embodiment, in order to prevent the transmission of the first signal 301 from being canceled as the transmission of the first signal 301 and the second signal 302 violates the SAR standard, the electronic device 101 may transmit one of the first signal 301 or the second signal 302 by controlling the transmission path.

The electronic device 101 may generate a packet data convergence protocol (PDCP) protocol data unit (PDU) in a PDCP layer and transfer the generated PDCP PDU to a radio link control (RLC) layer. According to an embodiment, data generated in the PDCP layer and transmitted to the RLC layer may be transmitted to a base station through a medium access control (MAC) layer and a physical interface transceiver (PHY) layer.

According to another embodiment, in the EN-DC environment of transmitting the first signal 301 and the second signal 302, the electronic device 101 may transfer a PDCP PDU generated in the PDCP layer only to an RLC layer for one signal selected from among the first signal 301 or the second signal 302. For example, in order to prevent the transmission of the first signal 301 from being cancelled, the electronic device 101 may transmit only the second signal 302 supporting the LTE network, by transferring the PDCP PDU only to an RLC layer of a long-term evolution (LTE) protocol. For another example, in order to prevent the transmission of the first signal 301 from being cancelled, the electronic device 101 may transmit only the first signal 301 supporting the NR network, by transferring data generated in the PDCP layer to an RLC layer of a new radio (NR) protocol.

According to another embodiment (not shown), the electronic device 101 may control a transmission path of the first signal 301 and the second signal 302 by controlling an electrical path. According to an embodiment, the electronic device 101 (or the at least one processor 340) may control the transmission path of the first signal 301 and the second signal 302 by controlling the RFFE 320. For example, the at least one processor 340 may transmit only the second signal 302 through the at least one antenna 310 by controlling the BPF 322. For another example, the at least one processor 340 may transmit only the second signal 302, by controlling at least one switch (not shown) arranged between the wireless communication circuit 330 and the at least one antenna 310.

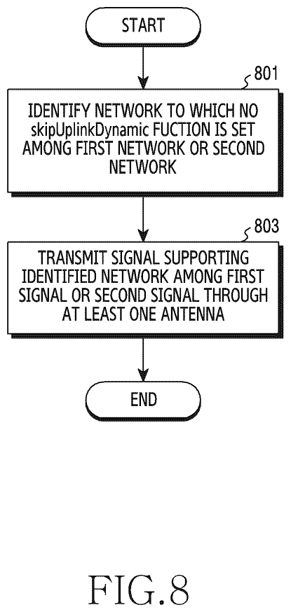

FIG. 8 is a flowchart illustrating an operation of selecting and transmitting one of a first signal or a second signal depending on whether a function for a first network and a second network is set, according to an embodiment of the disclosure.

Referring to FIG. 8, the electronic device 101 of an embodiment may determine whether a specified function is set to a first network and a second network, and transmit one of the first signal 301 or the second signal 302, based on the determination result. The operation of FIG. 8 of an embodiment may be referred to as a specific operation of operation 505 of FIGS. 5 and 6.

In operation 801, the electronic device 101 may identify a network to which no specified function (e.g., skipUplinkDynamic function) is set among the first network or the second network.

According to an embodiment, a network to which a skipUplinkDynamic function is set may be allocated transmission resources from a base station, and when a signal to be transmitted includes no user data, the network to which the skipUplinkDynamic function is set may omit the transmission of the signal. According to an embodiment, when the signal to be transmitted includes no user data, the network to which the skipUplinkDynamic function is set may reduce transmission power by omitting the transmission of the signal, and through this, may reduce a possibility that the sum of power of transmitted signals (e.g., the first signal 301 and the second signal 302) exceeds maximum power. At this time, as the possibility that the sum of power of the transmitted signals exceeds the maximum power is reduced, a possibility of occurrence of transmission cancellation may also be reduced.

Since a signal supporting a network to which a skipUplinkDynamic function is set has a relatively low probability of occurrence of transmission cancellation, a transmission path may be controlled to transmit a signal supporting a network to which no skipUplinkDynamic function is set.

In operation 803, the electronic device 101 may transmit the signal supporting the network identified through operation 801 among the first signal 301 or the second signal 302 through the at least one antenna 310. According to an embodiment, in operation 803, the electronic device 101 may transmit, through the at least one antenna 310, the signal supporting the network to which no skipUplinkDynamic function is set among the first signal 301 or the second signal 302. For example, in operation 803, the electronic device 101 may transmit the second signal 302 supporting an NR network to which no skipUplinkDynamic function is set, through the at least one antenna 310.

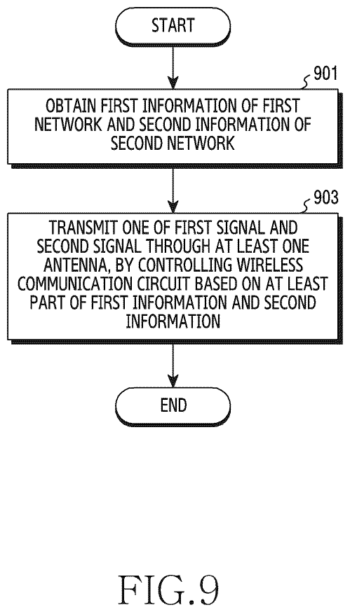

FIG. 9 is a flowchart illustrating an operation of selecting and transmitting one of a first signal or a second signal, based on first information of a first network and second information of a second network, according to an embodiment of the disclosure.

Referring to FIG. 9, the electronic device 101 of an embodiment may obtain first information of a first network and second information of a second network, and may transmit one of the first signal 301 or the second signal 302, based on at least part of the obtained information. The operation of FIG. 9 of an embodiment may be referred to as a specific operation of operation 505 of FIGS. 5 and 6.

In operation 901, the electronic device 101 may obtain first information of a first network and second information of a second network. According to an embodiment, the electronic device 101 (or at least one processor 340) may obtain the first information of the first network and the second information of the second network through the wireless communication circuit 330.

According to another embodiment, the first information and the second information may be referred to as uplink throughputs predicted for respective networks. For example, the first information may be referred to as an uplink throughput expected for an NR network and second information may be referred to as an uplink throughput expected for an LTE network.

The first information and the second information may be referred to as uplink throughputs measured for respective networks. For example, the first information may be referred to as an uplink throughput measured for an NR network, and the second information may be referred to as an uplink throughput measured for an LTE network.

In operation 903, the electronic device 101 may transmit one of the first signal 301 or the second signal 302 through the at least one antenna 310, based on at least part of the first information and the second information obtained through operation 901. According to an embodiment, in operation 903, the electronic device 101 may transmit one of the first signal 301 or the second signal 302 through the at least one antenna 310, by controlling the wireless communication circuit 330, based on at least part of the first information and the second information obtained through operation 901.

According to yet another embodiment, in operation 903, the electronic device 101 may compare the uplink throughput of the first network and the uplink throughput of the second network obtained through operation 901 and transmit a signal supporting a network having a higher uplink throughput. For example, when an NR (e.g., 5G) network has a higher uplink throughput compared to an LTE network, the electronic device 101 may transmit the first signal 301 supporting the NR network through the at least one antenna 310. For another example, when the LTE network is predicted to have a higher uplink throughput compared to the NR (e.g., 5G) network, the electronic device 101 may transmit the second signal 302 supporting the LTE network through the at least one antenna 310.

An electronic device 101 of an embodiment may include a wireless communication circuit 330, at least one antenna 310 connected to the wireless communication circuit 330 and transmitting a first signal 301 supporting a first network and a second signal 302 supporting a second network distinguished from the first network, and at least one processor 340 electrically connected to the wireless communication circuit 330. The at least one processor 340 may, for example, obtain a power reduction amount 410 based on first target power 401 and first transmission power 431 of the first signal 301 while transmitting the first signal 301 and the second signal 302 through the at least one antenna 310, compare the power reduction amount 410 with a first reference value and a second reference value 420 less than the first reference value, and when the power reduction amount 410 is greater than the first reference value based on the comparison result, transmit one of the first signal 301 or the second signal 302 through the at least one antenna 310 by controlling the wireless communication circuit 330.

According to an embodiment, the at least one processor 340 may receive at least one of the first reference value or the second reference value 420 from a base station through the wireless communication circuit 330.

The first target power 401 may be referred to as a smaller value among a maximum power value that may be used to transmit the first signal 301 and a transmission power value received from the base station.

According to an embodiment, when the power reduction amount 410 is less than the first reference value and is greater than the second reference value 420 and the first signal 301 includes control data, the at least one processor 340 may transmit one of the first signal 301 or the second signal 302 through the at least one antenna 310.

According to another embodiment, when the power reduction amount 410 is less than the first reference value and is greater than the second reference value 420 and the first signal 301 includes user data, the at least one processor 340 may determine whether the first signal 301 satisfies a specified condition during a specified time, and in response to the first signal 301 satisfying the specified condition, transmit one of the first signal 301 or the second signal 302 through the at least one antenna 310.

The specified condition of an embodiment may include at least one of when the number of times where the power reduction amount 410 is greater than or equal to the second reference value 420 is greater than or equal to a predetermined first threshold value during the specified time, when the number of times where the power reduction amount 410 is greater than or equal to the second reference value 420 occurs continuously greater than or equal to a predetermined second threshold value during the specified time, and when a rate at which the power reduction amount 410 is greater than or equal to the second reference value 420 is greater than or equal to a predetermined third threshold value during the specified time.

According to still another embodiment, the at least one processor 340 may determine whether a skipUplinkTxDynamic function is set to the first network or the second network, and transmit a signal supporting a network to which no skipUplinkTxDynamic function is set among the first network or the second network, among the first signal 301 and the second signal 302, through the at least one antenna 310.

When a signal supporting a network to which the skipUplinkTxDynamic function is set includes no user data, the network to which the skipUplinkTxDynamic function is set among the first network or the second network of an embodiment may omit the transmission of the signal, based on scheduling information received from a base station.

In an embodiment, the at least one processor 340 may compare uplink throughputs of the respective first network and second network with each other through the wireless communication circuit 330, and transmit one of the first signal 301 and the second signal 302 through the at least one antenna 310, based on the comparison result.

In another embodiment, the first reference value may be determined based on the second reference value 420, and the second reference value 420 may be referred to as about 0 dB or about 6 dB.

A wireless communication method of an embodiment may include, while transmitting, through at least one antenna 310, a first signal 301 supporting a first network and a second signal 302 supporting a second network distinguished from the first network, obtaining a power reduction amount 410 based on first target power 401 and first transmission power 431 of the first signal 301, comparing the obtained power reduction amount 410 with a first reference value and a second reference value 420 less than the first reference value, and when the power reduction amount 410 is greater than the first reference value based on the comparison result, transmitting one of the first signal 301 or the second signal 302 through the at least one antenna 310 by controlling a wireless communication circuit 330.

The wireless communication method may further include receiving at least one of the first reference value or the second reference value 420 from a base station through the at least one antenna 310 by controlling the wireless communication circuit 330.

According to an embodiment, the wireless communication method may include, when the power reduction amount 410 is less than the first reference value and is greater than the second reference value 420, identifying a network to which no skipUplinkTxDynamic function is set among the first network or the second network, and transmitting a signal supporting the identified network among the first signal 301 and the second signal 302 through the at least one antenna 310.

When a signal supporting a network to which a skipUplinkTxDynamic function is set includes no user data, the network to which the skipUplinkTxDynamic function is set among the first network or the second network may omit the transmission of the signal, based on scheduling information received from a base station.

According to an embodiment, the wireless communication method may include transmitting one of the first signal 301 or the second signal 302 through the at least one antenna 310, when the power reduction amount 410 is less than the first reference value and is greater than the second reference value 420 and the first signal 301 includes control data.

According to another embodiment, the wireless communication method may further include, when the power reduction amount 410 is less than the first reference value and is greater than the second reference value 420 and the first signal 301 includes user data, determining whether the first signal 301 satisfies a specified condition during a specified time, and in response to the first signal 301 satisfying the specified condition during the specified time, transmitting one of the first signal 301 or the second signal 302 through the at least one antenna 310.

The specified condition of an embodiment may be referred to as at least one of when the number of times where the power reduction amount 410 is greater than or equal to the second reference value 420 is greater than or equal to a predetermined first threshold value during the specified time, when the number of times where the power reduction amount 410 is greater than or equal to the second reference value 420 occurs continuously greater than or equal to a predetermined second threshold value during the specified time, and when a rate at which the power reduction amount 410 is greater than or equal to the second reference value 420 is greater than or equal to a predetermined third threshold value during the specified time.

According to still another embodiment, transmitting one of the first signal 301 or the second signal 302 through the at least one antenna 310 may further include obtaining a first uplink throughput of the first network and a second uplink throughput of the second network through the wireless communication circuit 330, comparing the first uplink throughput with the second uplink throughput, and transmitting one of the first signal 301 or the second signal 302 through the at least one antenna 310, based on the comparison result.

According to yet another embodiment, transmitting one of the first signal 301 or the second signal 302 through the at least one antenna 310, based on the comparison result of the uplink throughputs of the respective first network and second network may include transmitting a signal supporting a network having a higher uplink throughput among the first network and the second network.

An electronic device 101 of an embodiment may include a wireless communication circuit 330, at least one antenna 310 connected to the wireless communication circuit 330 and transmitting a first signal 301 supporting a first network and/or a second signal 302 supporting a second network distinguished from the first network, and at least one processor 340 electrically connected to the wireless communication circuit 330. The at least one processor 340 may, for example, obtain a power reduction amount 410 based on first target power 401 and first transmission power 431 of the first signal 301 while transmitting the first signal 301 and the second signal 302 through the at least one antenna 310, when the power reduction amount 410 is greater than a reference value, obtain first information about the first network and second information about the second network, and transmit one of the first signal 301 or the second signal 302 through the at least one antenna 310 by controlling the wireless communication circuit 330, based on at least part of the first information and the second information.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a wireless communication circuit;
at least one antenna connected to the wireless communication circuit and transmitting a first signal supporting a first network and a second signal supporting a second network distinguished from the first network;
at least one processor; and
memory storing instructions that, when executed by the at least one processor, cause the electronic device to:
obtain a power reduction amount based on first target power and first transmission power of the first signal while transmitting the first signal and the second signal through the at least one antenna,
compare the power reduction amount with a first reference value and a second reference value less than the first reference value, and
when the power reduction amount is greater than the first reference value based on the comparison result, transmit one of the first signal or the second signal through the at least one antenna by controlling the wireless communication circuit.

2. The electronic device of claim 1, wherein the instructions, when executed by the at least one processor, cause the electronic device to receive at least one of the first reference value or the second reference value from a base station through the wireless communication circuit.

3. The electronic device of claim 1, wherein the first target power is a smaller value among a maximum power value used to transmit the first signal and a transmission power value received from a base station.

4. The electronic device of claim 1, wherein the instructions, when executed by the at least one processor, cause the electronic device to, when the power reduction amount is less than the first reference value and is greater than the second reference value and the first signal comprises control data, transmit one of the first signal or the second signal through the at least one antenna.

5. The electronic device of claim 1, wherein the instructions, when executed by the at least one processor, cause the electronic device to:
when the power reduction amount is less than the first reference value and is greater than the second reference value and the first signal comprises user data,
determine whether the first signal satisfies a specified condition during a specified time; and
in response to the first signal satisfying the specified condition, transmit one of the first signal or the second signal through the at least one antenna.

6. The electronic device of claim 5, wherein the specified condition comprises at least one of when a number of times where the power reduction amount is greater than or equal to the second reference value is greater than or equal to a predetermined first threshold value during the specified time, when the number of times where the power reduction amount is greater than or equal to the second reference value occurs continuously greater than or equal to a predetermined second threshold value during the specified time, and when a rate at which the power reduction amount is greater than or equal to the second reference value is greater than or equal to a predetermined third threshold value during the specified time.

7. The electronic device of claim 1, wherein the instructions, when executed by the at least one processor, cause the electronic device to:
determine whether a skipUplinkTxDynamic function is set to the first network or the second network; and
transmit a signal supporting a network to which no skipUplinkTxDynamic function is set among the first network or the second network, among the first signal and the second signal, through the at least one antenna.

8. The electronic device of claim 7, wherein a network to which the skipUplinkTxDynamic function is set among the first network or the second network is configured to, when a signal supporting the network to which the skipUplinkTxDynamic function is set comprises no user data, omit the transmission of the signal, based on scheduling information received from a base station.

9. The electronic device of claim 1, wherein the instructions, when executed by the at least one processor, cause the electronic device to:
compare uplink throughputs of the respective first network and second network with each other through the wireless communication circuit; and
transmit one of the first signal and the second signal through the at least one antenna, based on the comparison result.

10. The electronic device of claim 1,
wherein the second reference value is 0 dB or 6 dB, and
wherein the first reference value is a value obtained by adding a predetermined value to the second reference value.

11. A wireless communication method, the method comprising:
while transmitting, through at least one antenna, a first signal supporting a first network and a second signal supporting a second network distinguished from the first network, obtaining a power reduction amount based on first target power and first transmission power of the first signal;
comparing the obtained power reduction amount with a first reference value and a second reference value less than the first reference value; and
when the power reduction amount is greater than the first reference value, based on the comparison result, transmitting one of the first signal or the second signal through the at least one antenna by controlling a wireless communication circuit.

12. The method of claim 11, further comprising:
receiving at least one of the first reference value or the second reference value from a base station through the at least one antenna by controlling the wireless communication circuit.

13. The method of claim 11, further comprising:
when the power reduction amount is less than the first reference value and is greater than the second reference value, identifying a network to which no skipUplinkTxDynamic function is set among the first network or the second network; and
transmitting a signal supporting the identified network among the first signal and the second signal through the at least one antenna.

14. The method of claim 13, wherein when a signal supporting a network to which a skipUplinkTxDynamic function is set comprises no user data, the network to which the skipUplinkTxDynamic function is set among the first network or the second network omits the transmission of the signal, based on scheduling information received from a base station.

15. The method of claim 11, comprising:
transmitting one of the first signal or the second signal through the at least one antenna, when the power reduction amount is less than the first reference value and is greater than the second reference value and the first signal comprises control data.

16. The method of claim 11, wherein the first target power is a smaller value among a maximum power value used to transmit the first signal and a transmission power value received from a base station.

17. The method of claim 11, wherein the specified condition comprises at least one of when a number of times where the power reduction amount is greater than or equal to the second reference value is greater than or equal to a predetermined first threshold value during the specified time, when the number of times where the power reduction amount is greater than or equal to the second reference value occurs continuously greater than or equal to a predetermined second threshold value during the specified time, and when a rate at which the power reduction amount is greater than or equal to the second reference value is greater than or equal to a predetermined third threshold value during the specified time.

18. The method of claim 11, further comprising:
comparing uplink throughputs of the respective first network and second network with each other through the wireless communication circuit; and
transmitting one of the first signal and the second signal through the at least one antenna, based on the comparison result.

19. The method of claim 11, further comprising:
determining whether a skipUplinkTxDynamic function is set to the first network or the second network; and
transmitting a signal supporting a network to which no skipUplinkTxDynamic function is set among the first network or the second network, among the first signal and the second signal, through the at least one antenna.

20. Non-transitory computer-readable storage medium storing one or more programs including instructions, when executed by at least one processor of an electronic device, cause the electronic device to:
while transmitting, through at least one antenna, a first signal supporting a first network and a second signal supporting a second network distinguished from the first network, obtain a power reduction amount based on first target power and first transmission power of the first signal;
compare the obtained power reduction amount with a first reference value and a second reference value less than the first reference value; and
when the power reduction amount is greater than the first reference value, based on the comparison result, transmit one of the first signal or the second signal through the at least one antenna by controlling a wireless communication circuit.
